(19) United States
(12) Patent Application Publication
(10) Pub. No.: US 2007/0207884 A1
(43) Pub. Date: Sep. 6, 2007

(54) VEHICLE

(75) Inventor: Toshio UNNO, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/681,298

(22) Filed: Mar. 2, 2007

(30) Foreign Application Priority Data
Mar. 2, 2006 (JP) 2006-056727

(51) Int. Cl. F16H 61/00; F16H 59/00

(52) U.S. Cl. 474/18; 474/17

(57) ABSTRACT

A vehicle includes a drive source, a continuously variable transmission, and a controller. The continuously variable transmission includes a primary sheave and a secondary sheave each having of a fixed flange and a movable flange. The movable flange of the primary sheave is moved by an electric motor to adjust the width of a groove of the primary sheave. The movable flange of the secondary sheave is normally urged in the direction to narrow the width of a groove of the secondary sheave by a spring and a secondary side actuator. The controller is connected to a sheave position detecting device, which outputs to the controller information on a position of the movable flange of the primary sheave during hard braking. When the vehicle is restarted, the controller controls the electric motor using the information on the position of the movable flange of the primary sheave.

### BACKGROUND OF THE INVENTION

1. Field of the Invention

The present invention relates to a vehicle, and more particularly to a vehicle with a controller that electronically controls a continuously variable transmission.

2. Description of the Related Art

V-belt continuously variable transmissions are used widely on straddle type vehicles such as scooter type motorcycles. The V-belt continuously variable transmission includes a primary shaft to which an output from a power source such as an engine is input, a secondary shaft for receiving the output and transmitting it to a drive wheel, and a pair of primary and secondary sheaves respectively disposed on the primary shaft and the secondary shaft for making the groove widths of the sheaves variable. A V-belt is wound around both of the sheaves, and a groove-width changing mechanism is used to change the groove widths of the sheaves to change the V-belt receiving diameters, thereby steplessly changing the speed change ratio of the primary sheave to the secondary sheave.

Each of the primary sheave and the secondary sheave is usually includes a fixed flange and a movable flange defining a V-groove therebetween. One of the movable flanges is arranged so as to move along the axis of the primary shaft and the other is arranged so as to move along the axis of the secondary shaft. The groove width changing mechanism moves the movable flange for continuous adjustment of the speed change ratio.

Some conventional V-belt continuously variable transmissions of this type use an electric motor to move the movable flange of the primary sheave so as to change the groove width thereof. The moving thrust from the electric motor permits the movement of the movable flange either in the direction to narrow the groove width of the primary sheave (toward Top) or in the direction to widen the groove width thereof (toward Low), making it possible to optimally change the groove width (see, for example, JP-B-3043061).

Other related vehicles are also disclosed in JP-B-Hei 7-86383 and JP-A-Hei 4-157242.

V-belt continuously variable transmissions are used in all terrain vehicles and off-road vehicles in addition to scooter type motorcycles. Such vehicles as all terrain vehicles and off-road vehicles are usually operated in snow or ice or over bad roads which can cause the drive wheels (rear wheels) to skid. In addition, due to high engine torque, the clutch mechanism for use in such vehicles is usually positioned between the engine and the primary sheave.

In the vehicles with a mechanical V-belt continuously variable transmission, engine speed is controlled using a throttle opening and vehicle speed, and the V-belt continuously variable transmission is operated by a belt pushing force controlled by a roller weight governor of the primary sheave and a spring and a torque cam assembly of the secondary sheave. As described above, all terrain vehicles and off-road vehicles are usually operated off-road or in snow which can cause skidding. When the driver applies hard braking during operation in such an environment, the drive wheels (rear wheels) may lock.

When this occurs in a vehicle with a mechanical continuously variable transmission, vehicle speed will sharply decrease and the rotational speed of the primary sheave will sharply decrease correspondingly, so that the thrust from the primary sheave will decrease. As a result, the movable flange of the primary sheave will move back toward Low due to a belt pushing force from the secondary sheave. As the rotational speed of the primary sheave sharply decreases, the clutch mechanism will be disconnected. As a result, the rotation of the primary sheave will stop when the wheels are locked.

At this time, the secondary sheave will also be stopped suddenly before the belt receiving diameter thereof shifts toward Low. At the same time, while the rotation of the primary sheave is stopped, no torque will be produced from the weight governor, so that the primary sheave will be held in an unstable position. As a result, the belt will be immovably engaged in the secondary sheave, and the primary sheave will be freely rotatable relative to the belt.

At this point, when the vehicle is restarted, the engine speed will increase to permit connection of the centrifugal clutch. Engine torque will be thus transmitted to the primary sheave to cause the primary sheave to rotate. However, since the primary sheave can rotate freely relative to the belt, neither the belt nor the secondary sheave will be driven.

Thereafter, as the engine speed increases and the rotational speed of the primary sheave increases correspondingly, the movable flange of the primary sheave will move suddenly toward Top, or in the direction to engage the belt due to the operation of the governor. When the belt is engaged in the primary sheave, the rotation of the primary sheave will be transmitted to the belt suddenly, causing the belt to rotate and also the secondary sheave to rotate. The vehicle is thus started.

As described above, the vehicle uses a sudden change in torque to start the vehicle. As a result, the starting operation of the vehicle may be jerky and the drive system thereof may be subjected to a heavy load. In addition, the vehicle will start with the speed change ratio slightly toward Top, resulting in low driving torque and thus undesirable acceleration. Further, shortly after the restart, the speed change ratio will shift suddenly toward Low due to the balance in force between the primary sheave and the secondary sheave. As a result, the driving torque may change suddenly, which gives discomfort to the rider.

The foregoing description involves the case where the mechanical continuously variable transmission is used. The use of an electronic continuously variable transmission involves even more disadvantages. Specifically, for the vehicle with the mechanical continuously variable transmission, a restart of the vehicle is barely possible even after the drive wheels are locked. However, for the vehicle with the electronic continuously variable transmission, a restart of the vehicle may be difficult in a locked state of the drive wheels. With reference to FIGS. 1 and 2, further description will be made below with respect to this problem.

In the electronic continuously variable transmission, the belt receiving diameter of the primary sheave is electronically controlled by a motor (electric motor). A shift control of the electronically controlled continuously variable transmission is performed based on a shift map prepared in advance. The shift map is usually provided with the inputs of vehicle speed and throttle opening.

As shown in FIG. 1, like the mechanical continuously variable transmission, the electronic continuously variable transmission is structured such that a secondary sheave 20 is normally urged in a direction to push a belt 30 by a spring 35 and a torque cam assembly (not shown in FIG. 1). A primary sheave 10 is thereby controlled while being normally urged toward Low. As the movable flange of the primary sheave 10 is moved toward Top, the belt receiving diameter of the primary sheave 10 will increase and the belt receiving diameter of the secondary sheave 20 will decrease correspondingly. As a result, a movable flange 20a of the secondary sheave 20 will be moved outward against the spring force, so that the speed change ratio will shift toward Top. FIG. 2 illustrates the state where hard braking is applied in the vehicle with such an electronic continuously variable transmission.

When vehicle speed is monitored in a location proximate to the rear wheel 50, if the rear wheel 50 stops, a vehicle speed of 0 will be detected. As a result, the primary sheave 10 will be controlled toward Low according to the shift map. At this time, since the secondary sheave 20 is stopped, the movement of the belt 30 will stop being engaged with the secondary sheave 20.

The primary sheave 10 will return to a shift map target position (Low position) with a decrease in the tension of the belt 30, independently of the movement of the secondary sheave 20. The primary sheave 10 can thereby rotate freely relative to the belt 30.

At this point, when the vehicle is restarted, engine speed will increase to permit the connection of a centrifugal clutch 40. As a result, the primary sheave, which can rotate freely relative to the belt 30, will start rotation. However, the belt 30 cannot be driven in such a state and thus the secondary sheave 20 continues to be stopped. The vehicle speed therefore continues to be 0.

As described above, the electronic continuously variable transmission is controlled based on the shift map. The shift map uses the vehicle speed and the throttle opening to determine the target speed change ratio. The target position at a vehicle speed of 0 is toward Low. At this time, any throttle operation results in an increase in the engine speed, and the primary sheave 10 continues to be positioned toward Low. As a result, no torque will be transmitted to the belt 30, so that the vehicle cannot be started.

### SUMMARY OF THE INVENTION

In order to overcome the problems described above, preferred embodiments of the present invention provide a vehicle which ensures a restart of the vehicle in a locked state of at least one drive wheel after hard braking.

In accordance with a preferred embodiment of the present invention, the vehicle includes a drive source that outputs power in response to a rider's operation of an accelerator, a continuously variable transmission connected to the drive source, and a controller that electronically controls the continuously variable transmission; in which the continuously variable transmission includes a primary sheave and a secondary sheave each having a fixed flange and a movable flange, each flange being attached to a rotary shaft; a belt received in a V-groove of each of the primary sheave and the secondary sheave, the width of the V-groove being variable to steplessly control a speed change ratio; an electric motor that moves the movable flange of the primary sheave to adjust the groove width of the primary sheave; and a spring and an actuator that urge the movable flange of the secondary sheave in the direction to narrow the groove width thereof; in which the electric motor is connected to the controller; in which the controller is connected to a sheave position detecting device that detects a position of the movable flange of the primary sheave, the sheave position detecting device outputting to the controller information on the position of the movable flange of the primary sheave during hard braking; and in which the controller controls the electric motor using the information on the position of the movable flange of the primary sheave during a restart of the vehicle.

In a preferred embodiment, the controller is connected to a storage device that stores the information on the movable flange of the primary sheave during the hard braking, and when the vehicle is restarted, the controller controls the electric motor to move the movable flange of the primary sheave to the position of the movable flange of the primary sheave during the hard braking.

In a preferred embodiment, the position of the movable flange of the primary sheave detected by the sheave position detecting device is continuously stored in the storage device.

In a preferred embodiment, during the restart of the vehicle, the controller sets the position of the movable flange of the primary sheave during the hard braking as a restart target position and controls the electric motor to move the movable flange of the primary sheave at a predetermined speed so as to achieve the restart target position, and when the movable flange of the secondary sheave starts rotation before the movable flange of the primary sheave reaches the restart target position, the controller controls the electric motor according to a driving map indicating the relationship between normal vehicle speed and a position of the movable sheave of the primary sheave.

In a preferred embodiment, during the restart of the vehicle, when the movable flange of the primary sheave has been moved beyond the predetermined position of the movable flange of the primary sheave by the electric motor, the controller stops the control of the electric motor.

In a preferred embodiment, the maximum speed of the electric motor is controlled by the controller.

In accordance with another preferred embodiment of the present invention, a vehicle includes a drive source that outputs power in response to rider's operation of an accelerator, a continuously variable transmission connected to the drive source, and a controller that electronically controls the continuously variable transmission; in which the continuously variable transmission includes a primary sheave and a secondary sheave each composed of a fixed flange and a movable flange, each flange being attached to a rotary shaft; a belt received in a V-groove of each of the primary sheave and the secondary sheave, the width of the V-groove being variable to control a speed change ratio steplessly; an electric motor that moves the movable flange of the primary sheave to adjust the groove width of the primary sheave; and a spring and a secondary side actuator that urge the movable flange of the secondary sheave in the direction to narrow the groove width thereof; in which the electric motor is connected to the controller; in which the controller is connected to a sheave slip motion detecting device that detects the slip motion of the primary sheave, the sheave slip motion detecting device outputting to the controller information on the slip motion of the primary sheave when at least one drive wheel of the vehicle is stopped and the drive source is idling; and in which the controller controls the electric motor until the primary sheave stops slipping.

In a preferred embodiment, the controller stops the movement of the movable flange of the primary sheave by the electric motor at a position of the primary sheave where the primary sheave stopped slipping to adjust the tension of the belt by the power of the drive source during idling.

In a preferred embodiment, the controller is connected to a sheave position detecting device that detects a position of the movable flange of the primary sheave; and during a restart of the vehicle, when the movable flange of the primary sheave has been moved beyond the predetermined position of the movable flange of the primary sheave by the electric motor, the controller stops the control of the electric motor.

In a preferred embodiment, the maximum speed of the electric motor is controlled by the controller.

In a preferred embodiment, the vehicle is preferably an all terrain vehicle.

In a preferred embodiment, a clutch mechanism of the vehicle is positioned between the primary sheave and the drive source.

According to a preferred embodiment of the present invention, a vehicle with a controller that electronically controls a continuously variable transmission includes a sheave position detecting device that detects a position of a movable flange of a primary sheave. The sheave position detecting device outputs to the controller information on the position of the movable flange of the primary sheave during hard braking. The controller controls an electric motor using the information on the position of the movable flange of the primary sheave for a restart of the vehicle. Therefore, a restart of the vehicle is ensured even after hard braking. Specifically, when the vehicle is restarted, the controller controls the electric motor to move the movable flange of the primary sheave to its position during the hard braking, which permits torque transmission from the primary sheave to a belt. A restart of the vehicle is thus ensured.

According to a preferred embodiment of the present invention, a vehicle with a controller that electronically controls a continuously variable transmission includes a sheave slip motion detecting device that detects the slip motion of the primary sheave. The sheave slip motion detecting device outputs to the controller information on the slip motion of the primary sheave when at least one drive wheel of the vehicle is stopped and a drive source is idling. The controller controls the electric motor until the primary sheave stops slipping. Therefore, a restart of the vehicle is ensured even after hard braking. Specifically, the controller stops the movement of the movable flange of the primary sheave by the electric motor at a position of the primary sheave where it stopped slipping to adjust the tension of the belt by the power of the drive source at idle. This permits torque transmission from the primary sheave to the belt. A restart of the vehicle is thus ensured.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic view illustrating the construction of a conventional continuously variable transmission.

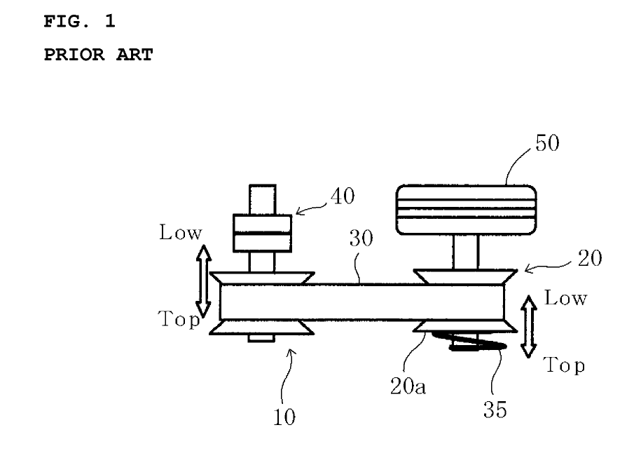

FIG. 2 is a schematic view of the continuously variable transmission shown in FIG. 1 during hard braking.

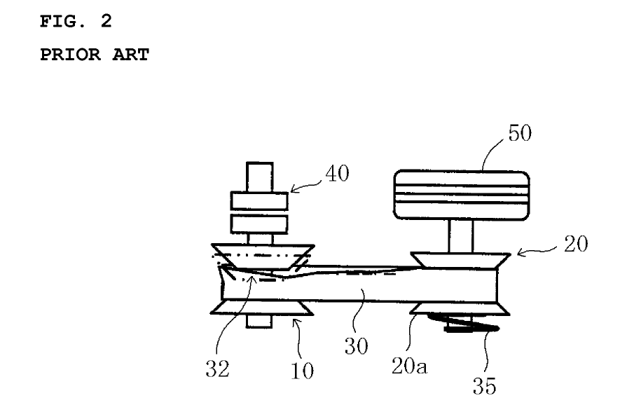

FIG. 3 is a schematic view illustrating the construction of a continuously variable transmission in accordance with a preferred embodiment of the present invention.

FIG. 4 is a schematic view illustrating the basic construction of the continuously variable transmission in accordance with a preferred embodiment of the present invention.

FIG. 5 illustrates a movable flange with a torque cam mechanism.

FIG. 6 is a side view of a vehicle having the continuously variable transmission in accordance with a preferred embodiment of the present invention.

FIG. 7 is a side view illustrating an area surrounding an engine.

FIG. 8 is a sectional view illustrating the structure of the engine and the continuously variable transmission.

FIG. 9 is a flowchart illustrating a method for operation in accordance with a preferred embodiment of the present invention.

FIG. 10 is a graph illustrating a shift change during a restart of a vehicle.

FIG. 11 is a flowchart illustrating a method for operation in accordance with another preferred embodiment of the present invention.

### DETAILED DESCRIPTION OF PREFERRED EMBODIMENTS

The preferred embodiments of the present invention are drawn to developing a vehicle that ensures a restart of the vehicle in a locked state of at least one drive wheel after hard braking. As an approach to preventing an incapability of a restart of the vehicle in such a state, the preferred embodiments of the present invention stop the movement of the primary sheave when the vehicle speed is 0. With this approach, the primary sheave is prevented from returning to a Low position, even when the belt is stopped.

More specifically, during a restart of the vehicle, the primary sheave is held at a position where it is stopped during hard braking until the belt starts to be driven. As the centrifugal clutch is connected, engine torque will be transmitted to the primary sheave to cause the primary sheave to rotate. The engine torque will then be transmitted to the secondary sheave via the belt. Therefore, a smooth restart of the vehicle is achieved. Further, the speed change ratio during the restart is slightly toward Top. Once the vehicle starts driving, the speed change ratio will be controlled smoothly to a normal value in response to a vehicle speed based on a shift map, thereby minimizing discomfort to the rider.

Unfortunately, despite the use of the above approach, the primary sheave may be moved toward Low by some external force after the vehicle is stopped. Also, the at least one drive wheel may stop immediately after hard braking, for example when hard braking is applied on ice. As a result, the shift operation will not be successfully stopped, resulting in a decrease in the tension of the belt.

The present inventor conceived of a vehicle in which when the eventually decreased tension of the belt permits free rotation of the primary sheave relative to the belt, the primary sheave is controlled optimally without giving an unnecessary load to the belt, thereby achieving a restart of the vehicle that is less uncomfortable to the rider.

With reference to the appended drawings, the preferred embodiments of the present invention will be described below. In the drawings, for the sake of simplifying explanation, components having substantially the same function are indicated with the same reference characters. It should be understood that the present invention is not limited to the described preferred embodiments.

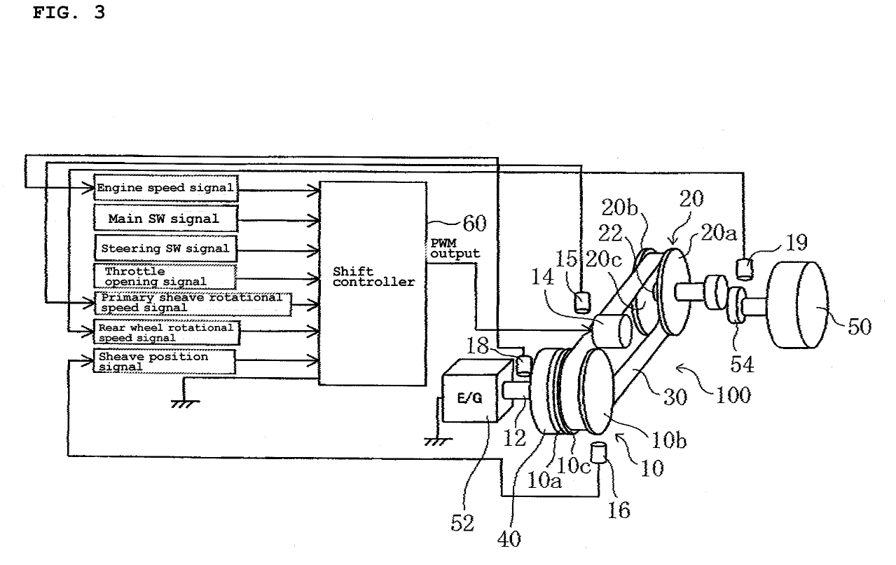

FIG. 3 is a schematic view illustrating the construction of a continuously variable transmission 100 on a vehicle in accordance with a preferred embodiment of the present invention. The vehicle in accordance with this preferred embodiment has a drive source 52, a continuously variable transmission 100 connected to the drive source, and a controller (shift controller) 60 that electronically controls the continuously variable transmission 100. In this preferred embodiment, the drive source 52 is an engine, which outputs power in response to a rider's operation of an accelerator (e.g., throttle).

The continuously variable transmission 100 is a belt continuously variable transmission. The belt continuously variable transmission 100 includes a primary sheave 10, a secondary sheave 20, and a belt 30 received in V-grooves 10c, 20c of the primary sheave 10 and the secondary sheave 20, respectively. The groove widths of the sheaves 10, 20 are made variable to change the speed change ratio steplessly.

The primary sheave 10 and the secondary sheave 20 each include a fixed flange 10a, 20a and a movable flange 10b, 20b, both of which are mounted on rotary shafts 12, 22, respectively. It should be noted that, the fixed flange may be referred to as “fixed sheave half” and the movable flange may be referred to as “movable sheave half”.

The groove width of the primary sheave 10 is adjusted as the movable flange 10b of the primary sheave 10 is controlled by an electric motor 14. The movable flange 20b of the secondary sheave 20 is normally urged in the direction to narrow the groove width of the secondary sheave by a spring (not shown) and a secondary side actuator (not shown in FIG. 3). The spring and the secondary side actuator will be discussed in greater detail below.

The electric motor 14 is connected to the controller (shift controller) 60 and is controlled using a PWM (Pulse Wide Modulation) method, for example. The controller 60 includes an electronic control unit (ECU). The electronic control unit (ECU) may be a microprocessing unit (MPU), for example. The controller 60 is connected to a sheave position detecting device 16 that detects a position of the movable flange 10b of the primary sheave 10. The sheave position detecting device 16 outputs to the controller 60 information on a position of the movable flange 10b (sheave position signal) during hard braking. The controller 60 controls the electric motor 14 using the information on the position of the movable flange 10b (sheave position signal), when the vehicle is restarted after the hard braking.

The controller 60 is also connected to a storage device (not shown) that stores information on a position of the movable flange 10b during hard braking. In this preferred embodiment, the storage device is included in the controller 60. The storage device can include a memory device (e.g., RAM or flash memory) or a hard disk, for example. The position of the movable flange 10b may be stored in the storage device at any time (e.g., continuously) as well as during hard braking.

In this preferred embodiment, when the vehicle is restarted after hard braking, the controller 60 controls the electric motor 14 to move the movable flange 10b of the primary sheave 10 to its position during the hard braking. Such control by the controller 60 ensures a restart of the vehicle after hard braking. More specifically, through control by the controller 60, the movable flange 10b of the primary sheave 10 is moved to its position during hard braking for when the vehicle is restarted. This will make the primary sheave 10 non-rotatable relative to the belt 30 (i.e., the tension of the belt 30 will not decrease), achieving transmission of torque from the primary sheave 10 to the belt 30. As a result, even after hard braking, a restart of the vehicle is ensured.

The vehicle in accordance with this preferred embodiment is preferably an all terrain vehicle (ATV) such as a four-wheeled buggy (or off-road vehicle). Since the engine 52 for use in such a vehicle has a high torque, a clutch mechanism 40 is often positioned between the engine and the primary sheave.

In the preferred embodiment shown in FIG. 3, the engine 52 and the clutch mechanism 40 are connected to each other by a drive shaft 12, and the clutch mechanism 40 is preferably a centrifugal clutch. The centrifugal clutch 40 transmits driving force to the primary sheave 10 when the speed of the engine 52 reaches a predetermined value.

The continuously variable transmission 100 is provided with an engine speed sensor 18 that detects the speed of the engine 52. The engine speed sensor 18 is electrically connected to the controller 60 and outputs an engine speed signal to the controller 60. The continuously variable transmission 100 is also provided with a primary sheave rotational speed sensor 15. The primary sheave rotational speed sensor 15 is electrically connected to the controller 60 and outputs a primary sheave rotational speed signal to the controller 60.

The primary sheave 10 is connected to the secondary sheave 20 via a V-belt 30 preferably made of an elastomer such as rubber or resin. The secondary sheave 20 includes a fixed flange 20a and a movable flange 20b. The movable flange 20b is connected to a rear wheel 50 via a reduction mechanism 54. In a location proximate to the rear wheel 50, there is provided a rear wheel rotational speed sensor 19 that detects the rotational speed of the rear wheel 50. The rear wheel rotational speed sensor 19 is electrically connected to the controller 60 and outputs a rear wheel rotational speed signal to the controller 60. It should be noted that the controller 60 can also receive a main switch signal, a steering switch signal, and a throttle opening signal, as shown in FIG. 3.

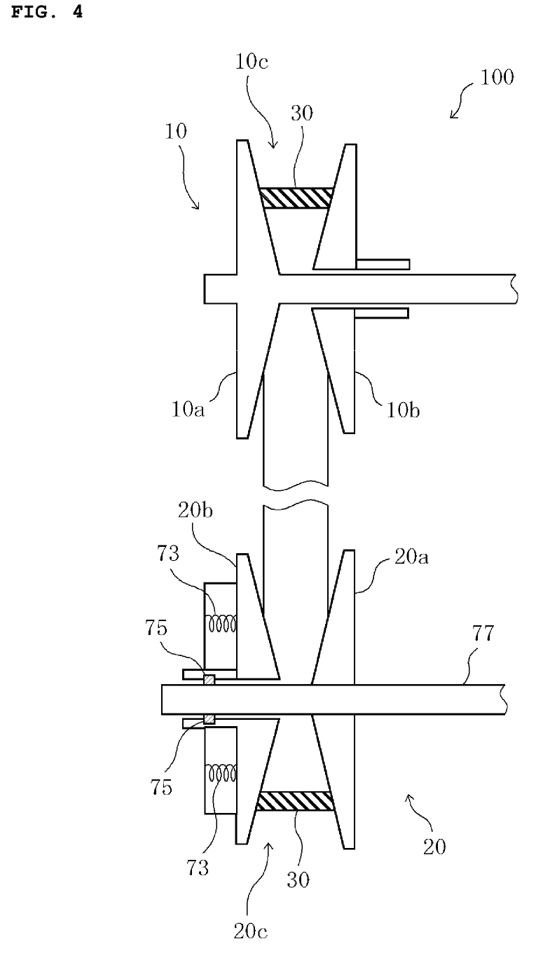

FIG. 4 is a schematic view illustrating the basic construction of a continuously variable transmission 100 in accordance with the present preferred embodiment. As described above, the movable flange 20b of the secondary sheave 20 is normally urged in the direction to narrow the width of the groove 20c by a spring 73 and a secondary side actuator 75. The belt 30 is received in the V-grooves 10c, 20c of the primary sheave 10 and the secondary sheave 20, respectively. The groove widths of the sheaves 10, 20 are made variable to change the speed change ratio steplessly.

The width of the groove 10c of the primary sheave 10 is adjusted as the movable flange 10b of the primary sheave 10 is moved by the electric motor 14. The movable flange 20b of the secondary sheave 20 is normally urged in the direction to narrow the width of the groove 20c by the spring 73. In the movable flange 20b of the secondary sheave 20, there is provided a secondary side actuator 75 to apply thrust axially of the movable flange 20b in response to a difference in torque between the fixed flange 20a and the movable flange 20b.

The actuator 75 can be a torque cam assembly, for example, including a cam groove formed in the movable flange 20b and a guide pin formed on a rotary shaft 77 slidably received in the cam groove. The structure of the actuator 75 is not critical as long as it is part of the movable flange 20b or the rotary shaft 77 to apply the thrust in the manner described above.

It should be noted that the torque of the movable flange 20b refers to engine torque or the load torque of the rear wheel 50 to be transmitted to the movable flange 20b via the belt 30 (the belt 30 is subjected to thrust from the spring 73 to prevent the belt from slipping) wound around the primary sheave 10 and the secondary sheave 20, in response to a running state of the vehicle.

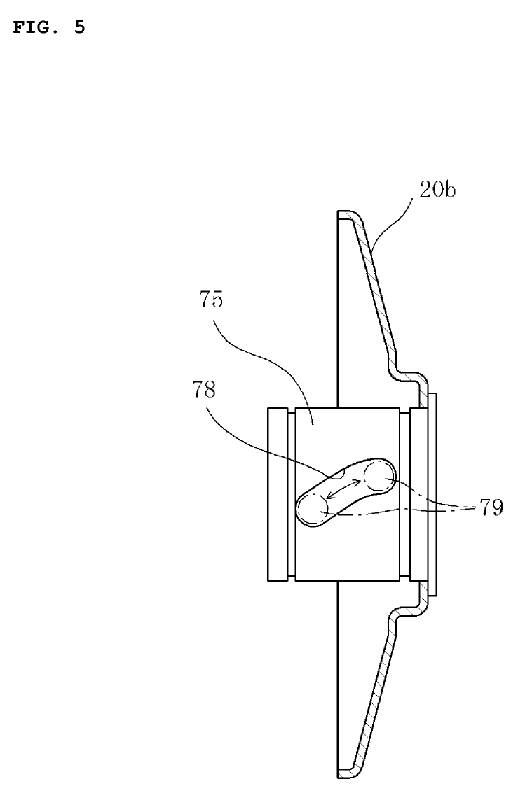

FIG. 5 illustrates the movable flange 20b with a torque cam assembly as the actuator 75 in accordance with a preferred embodiment of the present invention. In a part of the actuator 75 that includes the movable flange 20b, a cam groove 78 is inclined relative to the axial direction of the movable flange 20b. A guide pin 79 formed with the rotary shaft 77 is slidably received in the cam groove 78. When a difference in torque occurs between the rotary shaft 77 and the movable flange 20b, the guide pin 79 will be pressed by the wall of the cam groove 78, so that thrust will be applied to the movable flange 20b axially thereof.

It should be noted that changing the groove angle of the cam groove 78 changes the axial component of torque produced due to a difference in torque between the fixed flange 20a and the movable flange 20b, making it possible to vary thrust to be applied axially of the movable flange 20b, depending on shift ranges, for example.

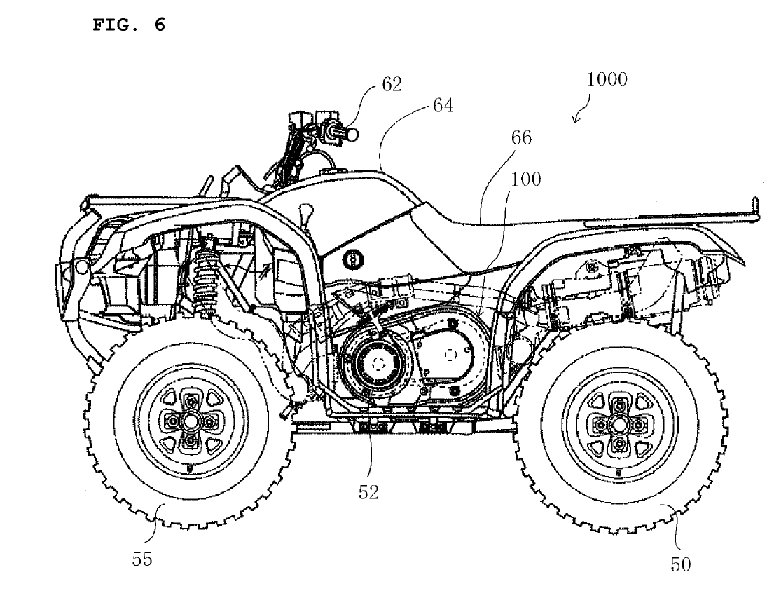

FIG. 6 illustrates a vehicle 1000 having a continuously variable transmission 100 in accordance with a preferred embodiment. The vehicle 1000 shown in FIG. 6 is an all terrain vehicle (i.e., four-wheeled buggy).

The all terrain vehicle 1000 includes rear wheels 50 as drive wheels, front wheels 55, and an engine 52 and a continuously variable transmission 100 both mounted between the front wheels 55 and the rear wheels 50. In an upper portion of the vehicle 1000, there are provided steering handlebars 62 used to turn the front wheels 55, a seat 66 straddled by a rider gripping the steering handlebars 62, and a fuel tank 64 disposed between the steering handlebars 62 and the seat 66.

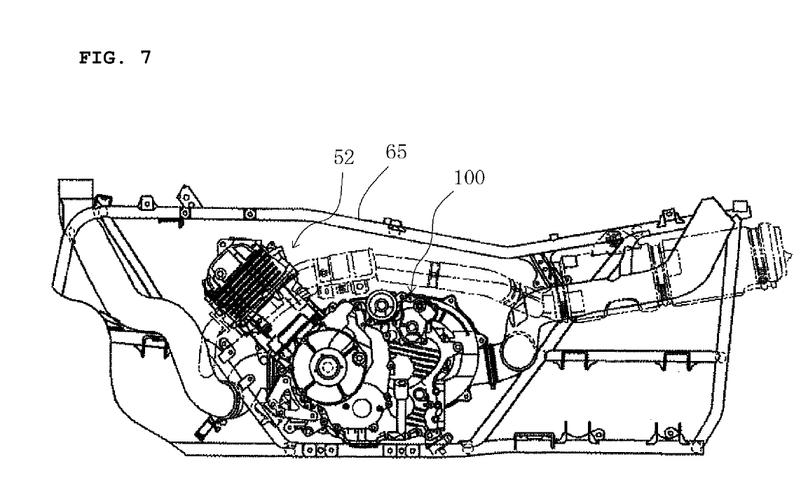

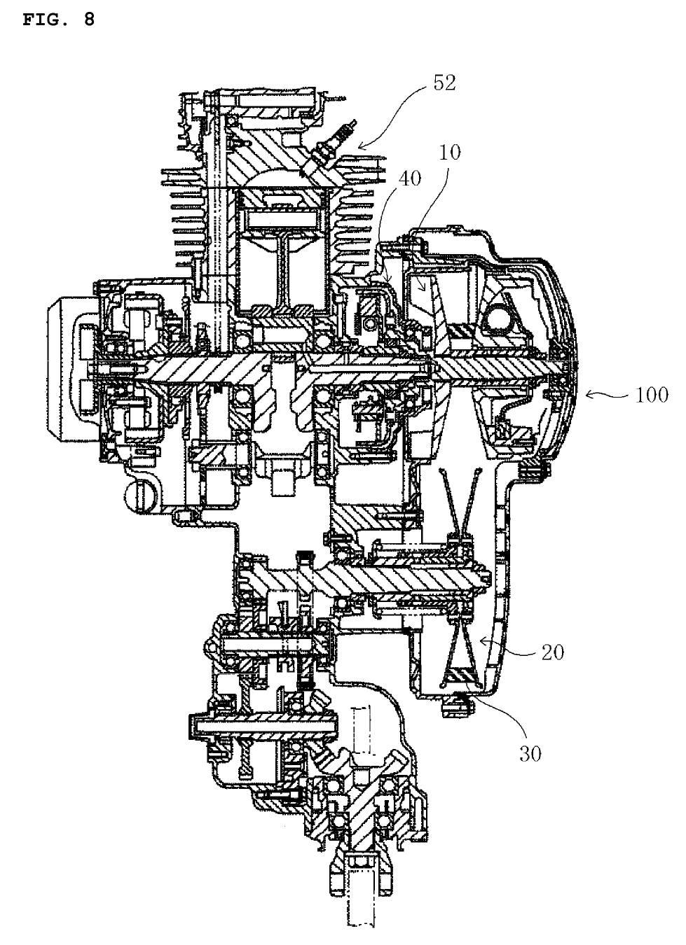

FIG. 7 illustrates an area surrounding the engine 52 of the all terrain vehicle shown in FIG. 6. The engine 52 and the continuously variable transmission 100 are mounted on a body frame 65. FIG. 8 illustrates the structure of the engine 52 and the continuously variable transmission 100 as viewed in a cross-sectional view. Between the engine 52 and the primary sheave 10 of the continuously variable transmission 100, the centrifugal clutch 40 is positioned. The continuously variable transmission 100 includes the primary sheave 10, the secondary sheave 20, and the belt 30 wound around the primary sheave 10 and the secondary sheave 20.

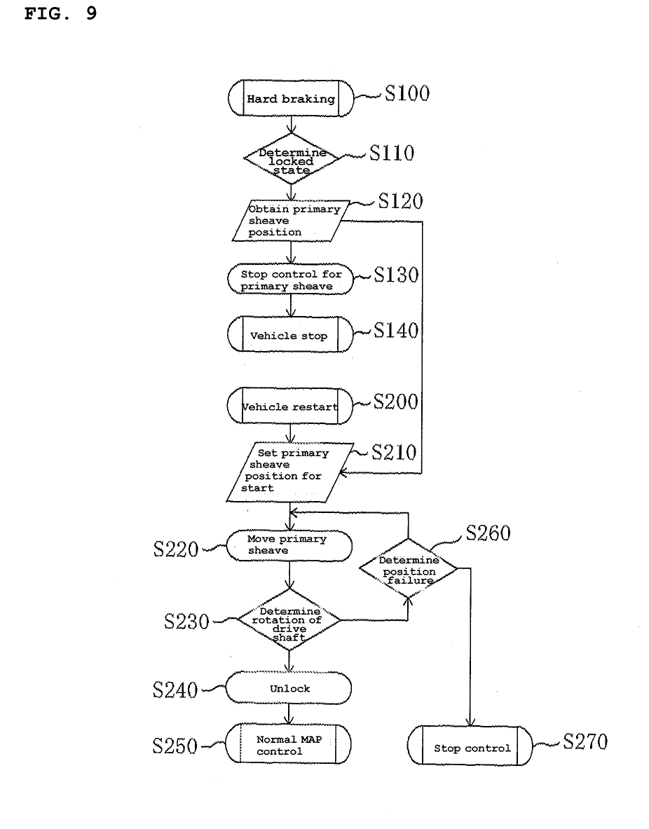

Referring also to FIG. 9, a method for operating and controlling the vehicle 1000 according to a preferred embodiment of the present invention will be described.

First, when the vehicle 1000 is braked suddenly or hard (S100) and a locked state of the rear wheel 50 is detected (S110), the process stores information on a position of the primary sheave 10 in such a locked state in a memory device (e.g., storage device in the controller 60) (S120). Then, the control for the primary sheave 10 is stopped (S130), and the vehicle 1000 stops.

When the vehicle is restarted (S200), the process moves the movable flange 10b of the primary sheave 10 to, or nearly to, its position stored in the memory device (restart mode, S210 and S220). It should be noted that a position of the movable flange 10b in a stopped state of the rear wheel 50 may be stored continuously as well as during hard braking in the memory device, so that the stored sheave position may be used as a sheave target value for a restart of the vehicle.

To avoid an abrupt change in the belt-transmitted torque, the movable flange 10b is moved softly to achieve the target value (S220). Specifically, there is an upper limit of the moving speed of the primary sheave 10. For the actual control, an upper limit of the movable amount of the movable flange 10b for one process cycle is set.

If the secondary sheave 20 (or the drive shaft 77) has started rotation before the movable flange 10b achieves the stored target value (S230), the movement of the movable flange 10b of the primary sheave 10 is stopped (termination of restart mode, S240) and the process proceeds to a normal map control based on the vehicle speed (S250). When the process proceeds to such control (S250), the process sets an upper limit of the moving speed of the movable flange 10b to prevent an abrupt change in torque.

If the movable flange 10b has achieved the stored target position and yet the secondary sheave 20 (or drive shaft 77) does not start rotation (S230), the movable flange 10b of the primary sheave 10 is moved further toward Top until the rotation of the secondary sheave 20 is detected. If the movable flange 10b has moved beyond the stored target position and to a limit position (e.g., Top position) and yet the secondary sheave 20 does not move, the process determines a failure of a drive system (S260) and ends the control (S270).

According to this method, during a restart of the vehicle, the movable flange of the primary sheave 10 is moved to its position at which it is stopped (S220), so that the tension of the belt 30 will be adjusted to permit torque transmission from the primary sheave 10 to the secondary sheave 20. Thereafter, the process proceeds to the normal map control (S250). As a result, a smooth restart of the vehicle is invariably achieved.

Further discussion will be provided for the process flow of FIG. 9. The process first obtains information on a position of the movable flange of the primary sheave 10 in a locked state of the rear wheel (S100, S110, and S120). It should be noted that obtaining such information may be executed upon detection of a vehicle speed of 0, instead of upon detection of hard braking. Upon obtaining the information on a position of the movable flange of the primary sheave 10 in the locked state of the rear wheel, the process stops control for the primary sheave 10 (S130).

When the vehicle is restarted (S200), the process sets a position of the movable flange of the primary sheave 10 at which the rear wheel stopped (position obtained at S120) as a target position (S210). When the driver opens a throttle valve, the process moves the movable flange 10b to the target position. Preferably, the maximum movable amount of the movable flange 10b is set to an upper limit of the movable amount of the movable flange 10b for one process cycle. Then, the process determines whether or not the drive shaft 77 has started rotation (S230). If the rotation has been started, the process unlocks the rear wheel (S240) and shifts the sheave target position to the one for the normal map control (S250). The transition to the normal map control is executed gradually with the maximum movable amount of the movable flange 10b unchanged. Finally, the vehicle 1000 will be driven in the normal map control. If non-rotation of the drive shaft has been determined in S230, the process determines a failure in the position of the movable flange 10b (S260) and also moves the movable flange 10b of the primary sheave 10 (S220). If a failure in the position of the movable flange 10b (S260) has been determined, the process stops the control (S270).

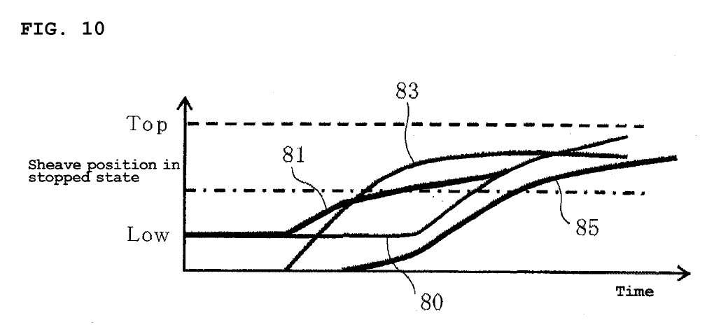

FIG. 10 is a graph illustrating a shift change during a restart of the vehicle. In this figure, the vertical axis represents a position of the movable flange 10b (Top-Low) at which the rear wheel stopped, and the horizontal axis represents time. Line 80 indicates a map target position, line 81 a position of the movable flange 10b, line 83 a throttle opening, and line 85 vehicle speed.

When a throttle valve (line 83) has been opened during a restart of the vehicle at S200 in FIG. 9, the movable flange of the primary sheave 10 will be moved at a predetermined speed to achieve its position at which the rear wheel stopped as a target position (line 83), as described above. When the tension of the belt 30 has been adjusted to permit torque transmission to the rear wheel 50, the rear wheel 50 will start rotation and the rotational speed thereof will increase (line 85). When the vehicle speed has been detected, the process calculates a shift target value for the normal map control using the vehicle speed and the throttle opening. Then, the target value will be changed to the map target value (line 80), and the primary sheave will be controlled so as to achieve the map target value.

At this time, since the moving speed of the movable flange 10b has the upper limit to prevent an abrupt change in torque, the movable flange 10b (line 81) will gradually move so as to achieve the map target value (line 80). Once the movable flange (line 81) achieves the map target value (line 80), the normal map control will be executed (S250 in FIG. 9).

With the configuration of this preferred embodiment, a restart of the vehicle 1000 is ensured even after hard braking, as described above. The same operation can be provided in an alternative preferred embodiment, which will be described below.

In addition to the configuration shown in FIG. 3, a sheave slip motion detecting device is provided to detect the slip motion of the primary sheave 10. The sheave slip motion detecting device is connected to the controller 60. Specifically, the primary sheave rotational speed sensor 15 shown in FIG. 3 can be used to detect the slip motion of the primary sheave 10.

When the rear wheel 50 of the vehicle 1000 is stopped and the drive source (engine) 52 is idling, the sheave slip motion detecting device 15 outputs information on the slip motion of the primary sheave to the controller 60. The controller 60 in turn controls the electric motor 14 until the primary sheave 10 stops slipping.

In this preferred embodiment, the controller 60 stops the movement of the movable flange 10b by the electric motor 14 at a position of the primary sheave 10 where it stopped slipping. Then, the tension of the belt 30 is adjusted by the power of the idling drive source (engine) 52.

The tension of the belt 30 can be thus adjusted in this preferred embodiment, which ensures a restart of the vehicle 1000 even after hard braking.

Alternatively, when a position of the movable flange 10b is detected using the sheave position detecting device 16, if the movable flange 10b is moved beyond a predetermined position by the electric motor 14 during a restart of the vehicle, the controller 60 may stop the control of the electric motor 14.

More specifically, when the tension of the belt 30 is decreased due to hard braking or the like and the engine is idling, some of engine torque is transmitted to the primary sheave 10 due to the rotation of the centrifugal cutch 40 with the engine. As a result, the primary sheave 10 slips. Detecting the slip motion of the primary sheave 10 and moving the primary sheave 10 to a position where the primary sheave will stop slipping can adjust the tension of the belt 30. A restart of the vehicle is thereby ensured.

Description will be made of the operation of the process in accordance with this preferred embodiment. The process first detects a slip motion of the primary sheave when the rear wheel is locked and the engine is idling. Then, after the locked state of the rear wheel is detected, the movable flange of the primary sheave 10 is moved toward Top to adjust the tension of the belt 30. At this time, an upper limit of the moving speed of the movable flange 10b is set to prevent an abrupt change in the belt-transmitted torque.

Thereafter, when the slip motion of the primary sheave is stopped, the process determines that the tension of the belt 30 is adjusted, and stops the movement of the movable flange 10b. As such, a decrease in the tension of the belt when the engine is idling can be adjusted to make the vehicle ready for restarting. The vehicle may start with the speed change ratio slightly toward Top compared to a normal state. However, when the wheels start rotation, the process gradually proceeds to the normal map control, thereby effecting smooth acceleration.

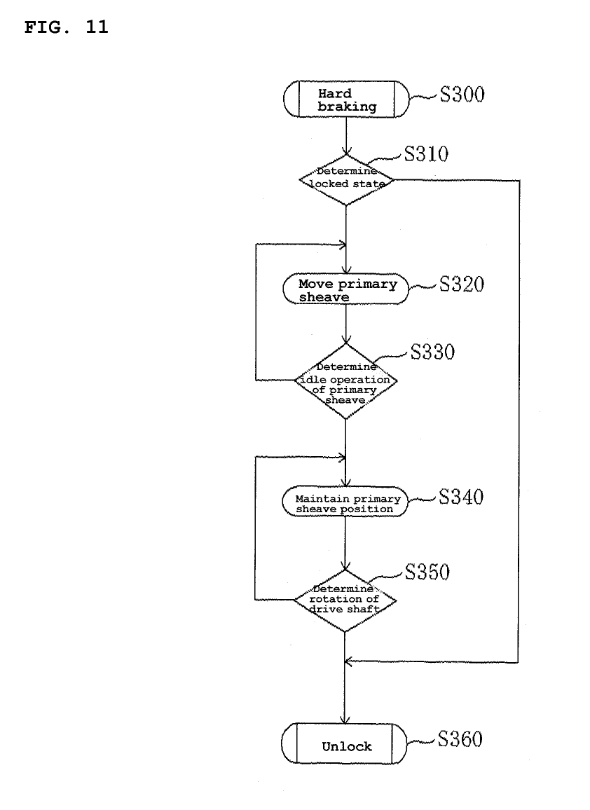

Referring also to the process flow of FIG. 11, further discussion will be given to this preferred embodiment.

When hard braking occurs (S300), the process determines a locked state of the rear wheel (S310). The rear wheel is determined to be locked if the rotational speed of the rear wheel axel is 0 and the primary sheave is slipping. The time required for the determination is, for example, about 100 ms. The locked state of the rear wheel is determined based on the continuance of the slip motion of the primary sheave during this period.

After determining the locked state of the rear wheel (S310), a certain movable amount of the movable flange of the primary sheave toward Top is added to a sheave target value, and then the process moves the movable flange of the primary sheave 10 (S320). Thereafter, the process determines a slip motion of the primary sheave 10 (S330). The primary sheave 10 is determined to be slipping (S330) if the rotation of the primary sheave 10 is stopped. The time required for this determination is, for example, about 50 ms. The slip motion of the primary sheave is determined based on the continuance of the stopped state of the primary sheave during this period.

If the determination (S330) is YES, or the primary sheave 10 continues to be stopped, the target value of the movable flange of the primary sheave is maintained (S340). If the determination (S330) is NO, or the primary sheave 10 does not continue to be stopped, a certain movable amount of the movable flange of the primary sheave toward Top is added to the sheave target value again, and then the process moves the movable flange of the primary sheave 10 (S320). Thereafter, the determination (S330) is executed. The determination (S330) is repeated until YES is determined.

When YES is determined at S330, the process determines that the tension of the belt is adjusted, and goes into a standby mode for a start of the normal driving (the position of the primary sheave 10 is maintained (S340)). When the throttle valve is opened at this time, the process starts the normal map control. Alternatively, the process can proceed to the preceding control for a restart (S200) when the throttle valve is opened, thereby making a restart of the vehicle more successful.

When the vehicle is restarted (S200), the process sets a position of the movable flange of the primary sheave 10 at which the rear wheel stopped (position obtained at S120) as a target position (S210). When the driver opens a throttle valve, the process moves the movable flange 10b to the target position. Preferably, the maximum movable amount of the movable flange 10b is set to an upper limit of the movable amount of the movable flange 10b for one process cycle. Then, the process determines whether or not the drive shaft 77 has started rotation (S230). If the rotation has been started, the process unlocks the rear wheel (S240) and shifts the sheave target position to the one for the normal map control (S250). The transition to the normal map control is executed gradually with the maximum movable amount of the movable flange 10b unchanged.

Finally, the vehicle 1000 will be driven in the normal map control. If non-rotation of the drive shaft has been determined in S230, the process determines a failure in the position of the movable flange 10b (S260) and also moves the movable flange 10b of primary sheave 10 (S220). If a failure in the position of the movable flange 10b (S260) has been determined, the process stops the control (S270).

The operation for a restart of the vehicle can be thus performed.

Although the present invention has been described above by way of preferred embodiments, the above descriptions should not be construed as limitations, but various modifications may be made.

In the foregoing preferred embodiments, the present invention is preferably applied to the all terrain vehicle 1000 as shown in FIG. 6. It should be understood, however, that the present invention is applicable to other types of four-wheeled buggies or three wheelers. It should also be understood that the present invention is applicable to straddle type vehicles including motorcycles. In the foregoing preferred embodiments, the centrifugal clutch 40 is positioned between the primary sheave 10 and the engine 52. Alternatively, the centrifugal clutch 40 may be positioned between the secondary sheave 20 and the rear wheel 50.

When any of the preferred embodiments of the present invention is to be applied to actual vehicles, specific implementations are preferably examined from a comprehensive viewpoint which allows for each and every requirement to be satisfied in order to produce an excellent effect such as described above.

According to the preferred embodiments of the present invention, a vehicle can be provided which ensures a restart of the vehicle in a locked state of at least one drive wheel after hard braking.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A vehicle comprising:
a drive source arranged to output power in response to an accelerator;
a continuously variable transmission connected to the drive source; and
a controller arranged to electronically control the continuously variable transmission; wherein
the continuously variable transmission includes:
a primary sheave and a secondary sheave each having a fixed flange and a movable flange, each flange being attached to a rotary shaft;
a belt received in a V-groove of each of the primary sheave and the secondary sheave, the width of the V-groove being variable to steplessly control a speed change ratio;
an electric motor connected to the controller and arranged to move the movable flange of the primary sheave to adjust the groove width of the primary sheave; and
a spring and an actuator arranged to urge the movable flange of the secondary sheave in a direction to narrow the groove width thereof;
the controller is connected to a sheave position detecting device arranged to detect a position of the movable flange of the primary sheave, the sheave position detecting device outputting to the controller information on the position of the movable flange of the primary sheave during hard braking; and
the controller controls the electric motor using the information on the position of the movable flange of the primary sheave during a restart of the vehicle.

2. The vehicle according to claim 1, wherein the controller is connected to a storage device that stores the information on the movable flange of the primary sheave during the hard braking; and when the vehicle is restarted, the controller controls the electric motor to move the movable flange of the primary sheave to the position of the movable flange of the primary sheave during the hard braking.

3. The vehicle according to claim 2, wherein the position of the movable flange of the primary sheave detected by the sheave position detecting device is continuously stored in the storage device.

4. The vehicle according to claim 1, wherein during the restart of the vehicle, the controller sets the position of the movable flange of the primary sheave during the hard braking as a restart target position and controls the electric motor to move the movable flange of the primary sheave at a predetermined speed so as to achieve the restart target position; and when the movable flange of the secondary sheave starts rotation before the movable flange of the primary sheave reaches the restart target position, the controller controls the electric motor according to a driving map indicating the relationship between a normal vehicle speed and a position of the movable sheave of the primary sheave.

5. The vehicle according to claim 4, wherein during the restart of the vehicle, when the movable flange of the primary sheave has been moved beyond the predetermined position of movable flange of the primary sheave by the electric motor, the controller stops the control of the electric motor.

6. The vehicle according to claim 1, wherein a maximum speed of the electric motor is controlled by the controller.

7. A vehicle comprising:
a drive source arranged to output power in response to an accelerator;
a continuously variable transmission connected to the drive source; and
a controller arranged to electronically control the continuously variable transmission; wherein
the continuously variable transmission includes:
a primary sheave and a secondary sheave each having a fixed flange and a movable flange, each flange being attached to a rotary shaft;
a belt received in a V-groove of each of the primary sheave and the secondary sheave, the width of the V-groove being variable to steplessly control a speed change ratio;
an electric motor connected to the controller and arranged to move the movable flange of the primary sheave to adjust the groove width of the primary sheave; and
a spring and an actuator arranged to urge the movable flange of the secondary sheave in a direction to narrow the groove width thereof;
the controller is connected to a sheave slip motion detecting device that detects a slip motion of the primary sheave, the sheave slip motion detecting device outputting to the controller information on the slip motion of the primary sheave when at least one drive wheel of the vehicle is stopped and the drive source is idling; and
the controller controls the electric motor until the primary sheave stops slipping.

8. The vehicle according to claim 7, wherein the controller stops the movement of the movable flange of the primary sheave by the electric motor at a position of the primary sheave where the primary sheave stopped slipping to adjust the tension of the belt by the power of the drive source during idling.

9. The vehicle according to claim 7, wherein the controller is connected to a sheave position detecting device that detects a position of the movable flange of the primary sheave; and during a restart of the vehicle, when the movable flange of the primary sheave has been moved beyond the predetermined position of the movable flange of the primary sheave by the electric motor, the controller stops the control of the electric motor.

10. The vehicle according to claim 7, wherein a maximum speed of the electric motor is controlled by the controller.

11. The vehicle according to claim 1, wherein the vehicle is an all terrain vehicle.

12. The vehicle according to claim 1, further comprising a clutch mechanism positioned between the primary sheave and the drive source.

13. The vehicle according to claim 7, wherein the vehicle is an all terrain vehicle.

14. The vehicle according to claim 7, further comprising a clutch mechanism positioned between the primary sheave and the drive source.
